(19) United States
(12) Patent Application Publication
(10) Pub. No.: US 2026/0297368 A1
(43) Pub. Date: Oct. 1, 2026

(54) PVDF DISPERSION COMPOSITIONS

(71) Applicant: SWIMC LLC, Cleveland, OH (US)

(72) Inventors: Dongrui YANG, Cleveland, OH (US); Ted BEST, Cleveland, OH (US); Amy GIEBELHAUS, Cleveland, OH (US); Nicole HARRIS, Cleveland, OH (US)

(21) Appl. No.: 19/474,967

(22) PCT Filed: Apr. 26, 2024
(86) PCT No.: PCT/US2024/026622

§ 371 Date: Oct. 13, 2025

Related U.S. Application Data
(60) Provisional application No. 63/498,592, filed on Apr. 27, 2023.

(51) Int. Cl. C09D 127/16; C08K 3/013; C08K 5/17; C09D 7/20; C09D 7/61; C09D 7/63; C09D 7/65

(52) U.S. Cl. CPC C09D 127/16; C08K 3/013; C08K 5/175; C09D 7/20; C09D 7/61; C09D 7/63; C09D 7/65

(57) ABSTRACT

The invention relates to a polyvinylidene fluoride (PVDF) solvent dispersion composition containing PVDF that is substantially free of fluorosurfactants and includes low levels of dispersants. PVDF is useful for producing tough, chemical-resistant coatings, especially on metallic substrates, including for use as a coil coating or an architectural coating. In embodiments disclosed herein, the PVDF coating composition includes solvents such as diisobutyl ketone (DIBK), which promotes the composition having advantageous viscosity and rheology even in the absence of fluorosurfactants and conventional solvents such as isophorone.

### CROSS-REFERENCE TO RELATED APPLICATIONS

This application claims priority to U.S. Provisional Patent Application Ser. No. 63/498,592, filed Apr. 27, 2023, the disclosure of which is incorporated herein by reference in its entirety.

### BACKGROUND

Fluoropolymer resins are used to produce high performance coatings. Among fluoropolymers, polyvinylidene fluoride (“PVDF”) is often preferred, as its dispersibility in common solvents and acrylic resins allows for formulation into a stable solvent dispersion that can be formulated into a liquid paint for application by various methods known in the art including, for example, reverse roll coating in a coil line. Such coatings are especially favored for application onto metal substrates, such as aluminum, hot dipped galvanized steel, and zinc-aluminum alloys on steel, where both excellent appearance and substrate protection must be maintained for a long period of time. Suitable PVDF dispersion coatings are as described in U.S. Pat. No. 7,399,533, for example.

In order to successfully apply a smooth and defect-free coating on a coil line, for example, the viscosity and solids content of the liquid coating must be carefully controlled. Conventionally, per- and poly-fluoroalkyl substances or surfactants were used to make fluoropolymer resins, but environmental concerns and regulatory changes have resulted in suppliers eliminating fluorosurfactants in the manufacture of fluoropolymers, leading to changes in coating formulation viscosity and rheology. As a result, fluoropolymer coating formulations must be altered in order to maintain desired properties, including optimal viscosity and rheology.

Typically, solvents and/or dispersants are used to control the viscosity and rheology of a coating formulation while maintaining or coating performance and characteristics. Suitable solvents include, for example, isophorone, glycol ether, glycol ether acetate, and the like. In particular, isophorone is commonly used in liquid coatings formulations, but isophorone may pose health and environmental hazards, and therefore, the use of isophorone may be reduced or even eliminated. In the absence of a solvent like isophorone, however, the coating formulation may demonstrate increased viscosity, poor heat stability, and other sup-optimal characteristics.

Accordingly, there remains a need for the development of PVDF dispersions or coatings that are substantially free from fluorosurfactants but use solvents that are environmentally friendly and provide optimal viscosity and rheology control and optimal performance characteristics.

### SUMMARY

The various embodiments of the present invention provide coating compositions containing PVDF that are substantially free from fluorosurfactant and thus minimize environmental problems associated with the use of flurorosurfactants. The coating composition can be applied by a variety of conventional methods and after curing provides a resilient, corrosion resistant, cured film.

The various embodiments herein provide for PVDF coating compositions that have a relatively long pot life, for storage and transportation, and/or exhibit high physical strength and excellent chemical resistance upon curing. In embodiments disclosed herein, the PVDF coating composition includes solvents such as, but not limited to, diisobutyl ketone (DIBK), which helps control the viscosity and rheology of the coating in the absence of fluorosurfactants and conventional solvents such as isophorone.

Accordingly, embodiments of the present application describe a coating composition having a dispersed fluoropolymer resin, said composition comprising: at least about 30 wt. % of PVDF polymer based on resin solids basis, and at least one organic solvent including a non-aromatic ester, a non-aromatic ketone or a mixture thereof.

Embodiments of the present application describe a composite material comprising a metal substrate having at least one surface which includes a PVDF based film formed by a process comprising: coating at least one surface with the coating composition of any of the preceding claims to form a coated metal substrate; and heating the coated metal substrate.

Embodiments of the present application describe a coating composition having a dispersed PVDF resin comprising: at least about 30 wt. % PVDF on a total resin solids basis; and organic solvent which includes between 0 and 20 wt. % of an organic solvent with an HSP Polarity δP≤6 and hydrogen-bonding component, δH≤10, based on the weight of the total composition.

“Embodiments of the present application describe a coating composition comprising: at least about 50 wt. % PVDF on a resin solid basis; a first organic solvent selected from the group consisting of: DIBK, DAA (diacetone alcohol), DB (diethylene glycol butyl ether), DPM (dipropylene glycol methyl ether), Aro 150 (Aromatic 150), EA Ac (Ethyl Acetoacetate), TMB (trimethylbenzene), EB Ac (ethylene glycol butyl ether acetate), PM Ac (propylene glycol methyl ether acetate), and mixtures thereof; and a second organic solvent which includes isophorone, xylenes, toluene, or a mixture thereof.”

The advantages and features which characterize the disclosure are pointed out with particularity in the claims annexed hereto and forming a part hereof. For a better understanding of the disclosure, however, reference should be had to the examples, which form a part hereof and to the accompanying descriptive matter, in which there is illustrated and described embodiments of the disclosure.

### BRIEF DESCRIPTION OF THE DRAWINGS

Non-limiting and non-exhaustive examples are described with reference to the following Figures.

FIG. 1 depicts the rheology profile (shear increase) of example compositions of the present disclosure.

FIG. 2A depicts the viscosity of an example composition of the present disclosure, utilizing a Brookfield viscometer at 10 rpm.

FIG. 2B depicts the viscosity of an example composition of the present disclosure, utilizing a Brookfield viscometer at 100 rpm.

FIG. 2C depicts the thixotropic index (also referred to as a thix index) of an example composition of the present disclosure.

FIG. 3 depicts the effect of DIBK on the viscosity of example PVDF formulations.

### DETAILED DESCRIPTION

The various embodiments of the present disclosure relate to a polyvinylidene fluoride (“PVDF”)-containing solvent-based composition or dispersion coating. The described composition or dispersion coating is useful for producing tough, chemical-resistant coatings, especially on metallic substrates, including for use as coil coating, architectural coating, and the like. Various embodiments described herein provide compositions containing substantially higher fluoropolymer and/or total solids loadings than conventional fluoropolymer coating compositions, forming stable formulations using PVDF that are substantially free of fluorosurfactants, which can enable higher application line speeds that improve productivity. In some examples, the compositions disclosed herein may result in robust coatings with high temperature cure, and solvents with high boiling points may decrease film defects such as blisters in the coatings. The PVDF coating composition described herein uses solvents such as, but not limited to, diisobutyl ketone (DIBK), which helps control the viscosity and rheology of the coating in the absence of fluorosurfactants and conventional solvents such as isophorone, while providing optimal performance characteristics and enhancing the effect of other additives and dispersants. The coating composition can be applied by a variety of conventional methods and after heating provides a resilient, corrosion resistant, cured film. In particular, various embodiments herein provide for polyvinylidene fluoride or polyvinylidene difluoride (“PVDF”) coating compositions that have a relatively long pot life for storage and transportation and exhibit high physical strength and excellent chemical resistance upon curing.

Aspects of the present disclosure relate to coating compositions which include a fluoropolymer resin dispersed in an organic solvent in the absence of fluorosurfactants and conventional solvents like isophorone. The fluoropolymer resin typically includes a vinylidene difluoride-based polymer and, preferably, PVDF. In an aspect, the solvent used to disperse the fluoropolymer resin component is a non-aromatic ester or ketone, preferably diisobutyl ketone (DIBK). The composition generally also includes a pigment and polymeric additives designed to improve the hardness and/or adhesion of the resulting cured film, e.g., a thermoplastic acrylic polymer or a combination of a hydroxy functional polymer and a curing agent. Depending on the desired properties of the final cured film, the composition may include other additives such as a flatting agent to reduce gloss or an additive to improve mar resistance. In some examples, the PVDF may be dispersed in an acrylic resin solution prepared in DIBK.

Aspects of the present disclosure also provide a method of coating a metal substrate to provide a cured vinylidene difluoride-based polymer film on at least one surface of the substrate. The method includes applying the coating composition onto a surface of the metal substrate to form a film, e.g., by roll coating or spraying the coating composition on the substrate surface. The coated metal substrate is then heated so that the coating layer cures to form a tough, cured film which adheres to the substrate surface. The coated metal substrate is cured by heating the vinylidene difluoride-based resin film to a temperature sufficient to coalesce the fluoropolymer resin.

Another aspect of the present disclosure provides a method to classify various solvents in coil coating formulations. This classification helps identify optimum solvents for a given paint or liquid coating systems.

### Selected Definitions

The term “fluoropolymer” denotes any polymer that has in its chain at least one monomer chosen from compounds containing a vinyl group capable of opening, in order to be polymerized, and that contains, directly attached to this vinyl group, at least one fluorine atom, at least one fluoroalkyl group, or at least one fluoroalkoxy group. Examples of fluoromonomers include, but are not limited to vinyl fluoride; vinylidene fluoride (VDF); trifluoroethylene (VF3); chlorotrifluoroethylene (CTFE); 1,2-difluoroethylene; tetrafluoroethylene (TFE); hexafluoropropylene (HFP); perfluoro(alkyl vinyl)ethers, such as perfluoro(methyl vinyl)ether (PMVE), perfluoro(ethyl vinyl)ether (PEVE) and perfluoro(propyl vinyl)ether (PPVE); perfluoro(1,3-dioxole); perfluoro(2,2-dimethyl-1,3-dioxole) (PDD). Preferred fluoropolymers are the homopolymers and copolymers of vinylidene fluoride. An especially preferred fluoropolymer is a homopolymer of vinylidene fluoride.

As used herein, the term “PVDF” refers to polyvinylidene fluoride or vinylidene difluoride. The PVDF may be a homopolymer, a copolymer, a terpolymer or a blend of a PVDF homopolymer or copolymer with one or more other polymers that are compatible with the PVDF in (co) polymer. PVDF copolymers and terpolymers of the invention are those in which vinylidene fluoride units comprise greater than 40 percent of the total weight of all the monomer units in the polymer, and more preferably, comprise greater than 70 percent of the total weight of the units. Copolymers, terpolymers and higher polymers of vinylidene fluoride may be made by reacting vinylidene fluoride with one or more monomers from the group consisting of vinyl fluoride, tritluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene. In certain aspects of the present disclosure the PVDF has a Mw of about 150,000 to about 500,000. More preferably the PVDF has a molecular weight (Mw) of about 350,000 to about 450,000, a molecular weight/mole number (Mw/Mn) ratio of about 3.5 to about 5.0, and/or a melting point of about 150-170° C. One example of a commercially available PVDF which is particularly suitable for use in the present composition is Kynar® 500.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

The terms “fluorosurfactant-free” and “substantially fluorosurfactant-free” as used herein mean less than 0.1% by weight of fluorosurfactants

The processes, systems, and compositions of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed processes and compositions.

As used herein, “weight percent,” “wt %,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt %,” etc.

As used herein, “g” represents gram; “L” represents liter; “mg” represents “milligram (10-3 gram);” “mL” represents milliliter (10-3 liter); “cm” represents centimeter (10-2 meter); micron represents 10-6 meter; “mm” represents millimeter (10-3 meter); “inch” is used as a length unit, and one inch equals to about 2.54 cm; “centipoise” or “cPs” or “cP” is used as a viscosity unit, and 1 cP=10-3 Pa·s=1 mPa·s. The temperature unit used herein is degree Celsius (° C.).

The term “about” is used in conjunction with numeric values to include normal variations in measurements, as expected by persons skilled in the art, and is understood to have the same meaning as “approximately” and to cover a typical margin of error, such as +10% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise.

In the interest of brevity and conciseness, any ranges of values set forth in this specification contemplate all values within the range, and are to be construed as support for claims, reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

Aspects of the coating compositions of the present disclosure include a fluoropolymer dispersion, i.e., a dispersion of the fluoropolymer resin particles in an organic solvent, such as a non-aromatic ketone or ester. Generally, the present compositions include at least about 30 wt. %, preferably at least about 35 wt. % and, more preferably, about 40-50 wt. % of a PVDF polymer resin (based on the total dry film weight of the coating composition). In some examples, the present compositions include at 47 wt. % of a PVDF polymer resin (based on the total dry film weight of the coating composition). In some instances, the PVDF polymer may constitute as much as about 70% to 95 wt. % of the resin solids. Aspects of the coating compositions of the present disclosure include a fluoropolymer dispersion, i.e., a dispersion of the fluoropolymer resin particles in an organic solvent, such as a non-aromatic ketone or ester. Aspects of the coating composition of the present disclosure may include an acrylic resin.

Generally, the present compositions include at least about 10-80 wt. %, preferably at least about 20-70 wt. % and, more preferably, about 25-60 wt. % of a non-volatile matter (“NVM” or “resin solids”) (based on the total wet weight of the coating composition). The PVDF polymer typically makes up at least about 30 wt. %, preferably at least about 35 wt. % and, more preferably, about 40-50 wt. % of the NVM (based on the total wet weight of the coating composition).

The present fluoropolymer resin-based compositions may also include a dispersant. While not limiting the invention, it is believed that the dispersant functions to maintain the spacing between fluoropolymer particles thereby acting as a dispersing aid. It has been found that dispersants commonly used in formulating pigment dispersions are suitable for use in the present compositions. The dispersant typically contains functionality capable of being absorbed on the surface of a pigment or fluoropolymer particle. Compounds including polar groups (e.g., amino groups) on one end, and a portion which is soluble in the continuous phase of the solvent (a hydrophobic tail) on the other end, are suitable for use as the dispersant. Typically, the present compositions include about 0.005 to about 5.0 wt. % and, preferably, about 0.01 to about 3.0 wt. % dispersant. When the composition includes a relatively high NVM (e.g., at least about 55 wt. %) and PVDF (e.g., at least about 35 wt. %) loading, from about 0.5 to about 3.0 wt. % of the dispersant is typically employed. Where the composition is a clear coating having a total NVM content of about 35-70 wt. % and a PVDF content of about 30-60 wt. %, lower levels of the dispersant (e.g. 0.01-2 wt. %) are generally employed. In some examples, the present compositions include 2 wt. % dispersant. In some examples, the present compositions include about 2 wt. % to about 4 wt. % dispersant. In some examples, the present compositions include about 3 wt. % to about 5 wt. % dispersant. In some examples, the present compositions include about 0.01 wt. % to about 4 wt. % dispersant.

A particularly suitable class of dispersants for use in the present compositions are referred to herein as “hyperdispersants.” As used herein, the term “hyperdispersant” refers to dispersant(s) which, when included in up to about 3 wt. % in a solvent-based formulation, permit preparation of stable dispersions containing at least about 90 wt. % PVDF (on a NVM basis) at PVDF loadings of about 35 wt. % or higher. Examples of suitable hyperdispersants include polymeric dispersants having one or more amino groups covalently bonded to the polymer. The hyperdispersants are typically employed in relatively low levels (e.g., 0.01-0.5 wt. %) in formulations containing about 25 to about 35 wt. % PVDF. When the formulation includes greater than about 40 wt. % PVDF, about 0.1 to about 3.0 wt. % of the hyperdispersant is generally employed.

In certain embodiments, preferred dispersants are phosphonic acids (and salts thereof), and some natural polymers or synthetic polymers. Polymeric dispersants may have different polymer architectures including linear, comb/branched, star, and dendritic (including dendrimers and hyperbranched polymers). Useful natural polymers include, but are not limited to proteins, such as glue, gelatine, casein, and albumin; naturally occurring rubbers, such as gum arabic and tragacanth; glucosides such as saponin; alginic acid and alginic acid derivatives, such as propylene glycol alginate; and cellulose derivatives, such as methyl cellulose, carboxymethyl cellulose and ethylhydroxy cellulose; wool and silk, and synthetic polymers.

In other embodiments, the dispersant may contain one or more amino groups covalently bonded to a polymer backbone or to pendant side chains of a polymer. Examples of suitable polymeric dispersants include oxyalkylated amines and polymeric polyester/polyamine condensates. Suitable oxyalkylated amines include oxyalkylated amino alcohols, such as Solsperse® 20000 (available from Zeneca, Inc.) and oxyalkylated alkyl amines such as Tetronic® 150R1 (available from BASF). Tetronic® 150R1 (herein “T150R1” or “T150”) is a polymer formed by the reaction of 1,2-ethanediamine with propylene oxide and ethylene oxide. Polymers of this latter type are generally referred to herein as a “polymeric oxyalkylated ethanediamine.” An example of a suitable polymeric polyester/polyamine condensate is commercially available under the tradename Solsperse® 27000, 28000, 36600, and 24000SC from Lubrizol, Inc.

Alternatively, amine groups may be linked to the polymer as an amine salt of a carboxylic acid group. Examples of such amine salt-containing dispersants include alkylol ammonium salts of acidic polyesters (e.g., Disperbyk®-180; available from BYK-Chemie, USA, Wallingford, Conn.); salts of unsaturated polyamine amides and higher molecular weight acidic esters such a Antiterra® U80 (BYK Chemie, USA). Another type of dispersant which may be used in the present composition are partial amides of higher molecular weight unsaturated polycarboxylic acids, such as Disperplast® I (available from BYK-Chemie, USA) and salts of long chain polyamine amides and polar acidic esters (such as Disperbyk® 101 from BYK Chemie). Others still include, high molecular weight polyester/polyurethane block copolymers (such as Disperbyk® 163 and Disperbyk® from BYK Chemie, Nuosprese® 9850 from Elementis Specialties). All of above dispersants can be used as supplied and incorporated into the fluoropolymer dispersion.

Aspects of embodiments of this disclosure relate to PVDF coating compositions that are free from or substantially free from fluorinated anionic dispersants. Fluorinated anionic dispersants are another class of hyperdispersants commonly referred to as fluorosurfactants. In certain aspects, embodiments described herein are substantially free, or even completely free, from fluorosurfactants.

Traditionally fluorosurfactant-free PVDF coatings were not possible in particular colors, including white. The substantially higher pigment loading required for a white coating composition led to high initial viscosity (Zahn #4), which led to poor hot box stability (+10 second Zahn #4). Alternative approaches to reduce the viscosity have included increasing the level of non-fluorosurfactants, which is limited due to subsequent changes in color development/appearance and the onset of haze in the coating. Other methods have included increasing the solvent level which reduces the solids of the formula (necessitating a reduced application line speed in order to meet a desired film thickness target), and also increases the volatile organic compound (“VOC”) concentration. Traditionally, a wide variety of organic solvents may be used to formulate the present fluoropolymer dispersions, including but not limited to, solvents such as isophorone, for example. The organic solvent typically acts as a latent solvent for the fluoropolymer; that is, the fluoropolymer is substantially insoluble and dispersed in the solvent at room temperature, but becomes solvated or dissolved in the solvent when the composition is heated. Some of these traditional solvents led to additional problems when included in the composition.

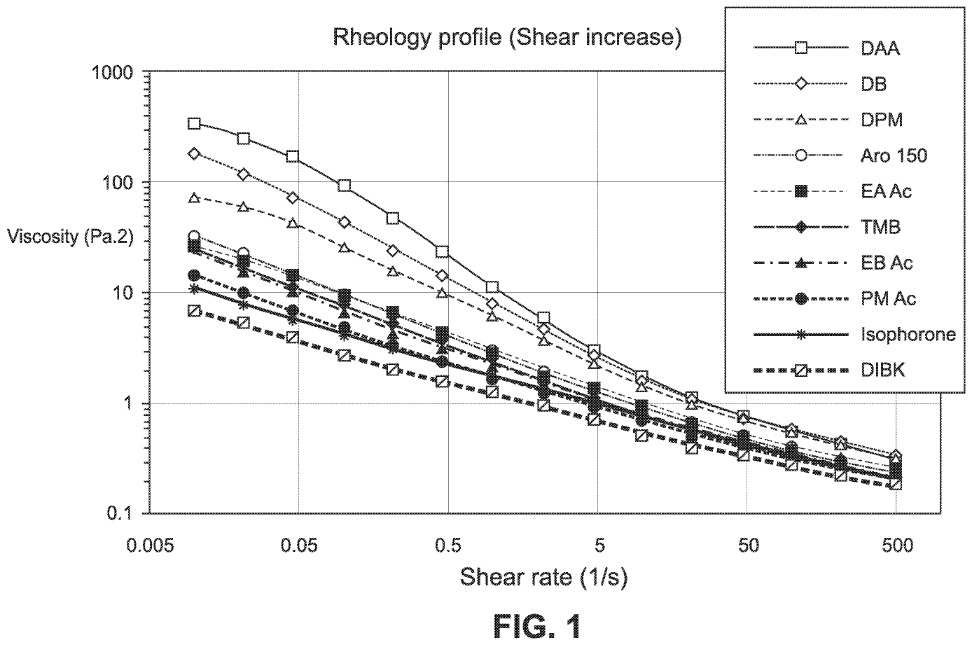

Surprisingly, Applicants have found that the compositions of the present disclosure have a reduced dispersion viscosity compared to traditional PVDF dispersions in organic solvents without the presence of the fluorosurfactants. The compositions of the present disclosure are particularly advantageous, in that they allow for increased PVDF resin solid content (or NVM content), which reduces the dispersion VOC level while preventing blistering and supports application at higher line speeds. Applicants have surprisingly found that the use of non-aromatic aliphatic ester or ketone, such as diisobutyl ketone (“DIBK”), for example, allows for a 100% fluorosurfactant-free PVDF coating, while maintaining color, viscosity and rheology characteristics (flow/more stable viscosity), and performance (including providing lot-to-lot consistency), without introducing additional problems (for example, hazing or blistering). Without being limited by theory, the presence of a non-aromatic aliphatic ester or ketone solvent, such as DIBK, enables reduction in the initial viscosity of the coating and the thixotropic index to a target range that typically results in improved stability during heat aging (hotbox stability) of the PVDF coating composition. In particular, in a white coating, for example, the combination of a higher concentration of DIBK along with a dispersing or wetting additive (e.g. BYK 2117) results in a large reduction in viscosity, which may enable higher solids product (?) within the current viscosity specifications. As shown in FIGS. 1-3 the viscosity of the coating compositions is improved by the presence of a combination of non-aromatic ester or ketone solvent and a dispersing or wetting additive.

The amount of solvent and/or type of solvent/cosolvent used may, in some examples, be dependent, at least in part, on the application method the composition is intended for (e.g spray or coil coating). In some examples, solvents that exhibit a relatively low boiling point may be less suitable for coil coating applications, as they may evaporate more quickly and may contribute to blistering. However, even in such coil coating applications, solvents that exhibit a relatively low boiling point may be used effectively as co-solvents along with at least one other solvent without contributing to negative effects.

The solvent generally makes up about 10 to about 50 wt. % and, preferably, about 25 to about 40 wt. % of the composition. In preferred embodiments of the present disclosure, which may be used in coil coating applications, the composition has a solvent component which includes at least 10-30 wt. % (on total solvent basis) solvent, having a boiling point between about 200° C. to about 300° C., and at least 10-25 wt. % of a non-aromatic ketone solvent having from about 6 to about 30 carbon atoms; more preferably from about 9 to about 20 carbon atoms. In some preferred embodiments of the present disclosure which may be used in coil coating applications, the composition has a solvent component which includes at least 10-30 wt. % (on total solvent basis) solvent isophorone and at least 10-25 wt. % of DIBK. Applicants have surprisingly found that the combination of a higher concentration of DIBK with a dispersing or wetting additive such as, for example, BYK-2117, results in a large reduction in viscosity for certain coatings with high pigment loading (e.g. white coatings), which may enable higher solids product within the current viscosity specifications. Applicants further have found that the presence of DIBK in compositions allows for more options on dispersants type and efficacy at lower levels. Further, the presence of DIBK in these compositions demonstrates less blistering online during coil coating application relative to to compositions using conventional solvents, such as acetate solvents, for example.

In other preferred embodiments of the present disclosure, which may be used in coil coating applications, the composition has a solvent component which includes at least 10-30 wt. % (on total solvent basis) solvent having a boiling point between about 200° C. to about 300° C. and at least 10-25 wt. % of a polyol diesters, such as triethylene glycol bis(2-ethylhexanoate) (“TEG-EH”), and esterfied ethers, e.g., esters of glycol monoethers such as propylene glycol methyl ether acetate (“PMA” or “PM acetate”) or dipropylene glycol methyl ester acetate (“DPMA” or “DPM acetate”). In another embodiment of the present disclosure, which may be used in coil coating applications, the composition has a solvent component which includes at least 10-30 wt. % (on total solvent basis) solvent having a boiling point between about 200° C. to about 300° C. and at least 10-25 wt. % of a includes a diester of a branched aliphatic diol, and more preferably, a butyrate diester of a branched octanediol, such as 2,2,4-trimethyl-1,3-pentanediol diisobutyrate (“TXIB”). Other preferred compositions include a solvent component consisting essentially of DIBK, PM acetate, DB acetate, DPM acetate, toluene, xylene, or mixtures thereof.

Hansen Solubility Parameters (“HSP”) have proven to be a powerful, practical way to understand issues of solubility, dispersion, diffusion, chromatography and more. Accordingly, in certain embodiments, a method to select an optimal solvent for dispersion of a fluoropolymer resin for coil coating is provided herein. In certain embodiments, the solvent is selected utilizing the three HSP parameters: SD for Dispersion (van der Waals), δP for Polarity (related to dipole moment) and δH for Hydrogen bonding. For reference, the HSP values of solvents used in the embodiments of the present disclosure are provided in Table 1. In certain aspects, compositions of the present disclosure contain organic solvents with a HSP Polarity δP≤4 and hydrogen-bonding component, δH≤6. In certain aspects, compositions of the present disclosure contain organic solvents with a HSP Polarity δP≤8 and hydrogen-bonding component, δH≤9. In certain aspects, compositions of the present disclosure contain organic solvents with a HSP Polarity δP≤12 and hydrogen-bonding component, δH≤15.

Table 1 below includes predicted Hanson Solubility Parameters for various solvents. These values were gathered from the database HSPiP 5th edition 5.3.06 (Hansen Solubility Parameters in Practice). The HSPiP database includes solubility parameters. The software of the HSPiP database allows for sortation of solvents relative to a target. To generate the data in the table below, the target was chosen to be DIBK, and the HSPiP database software was used to identify potential alternate solvents that may have a similar effect as DIBK based on their similar solubility parameter. To generate the data in Table 1, a small radius in space around DIBK was selected.

The data in Table 1 predicts that the lowest viscosities may be obtained utilizing solvents with Hansen solubility parameters in the range δP≤6 and δH≤10 (most preferred). Acceptable coating viscosities and storage stability may be obtained using solvents with Hansen solubility parameters in the range δP≤9 and δH≤7. Once the SH increases above a value of 8, obtaining stable viscosities becomes more difficult, even with a lower δP (δP≥6). These solvents may be suitable, in some examples, for use as a cosolvent.

The data in Table 1 predicts that the solvents that have an RED<1 (relative energy difference) are predicted to behave similarly to DIBK and to perform advantageously. Solvents with RED>1, for example, those with an RED>2, may still achieve desirable viscosity results as compared with DIBK, as the data in Example 1 demonstrates. Therefore, other solvents may be proposed as alternates to DIBK based on these solubility parameter characteristics and experimental data.

TABLE 1
Hanson Solubility Parameter of Exemplary Solvents

| | Solubility | | | | |
|---|---|---|---|---|---|
| | parameter | | | | |
| Solvent | δD | δP | δH | RED* | MVol |
| Di-Isobutyl Ketone (DIBK) | 16 | 3.7 | 4.1 | 0 | 177.4 |
| Bis(Ethylhexanoate) Triethylene | 16.1 | 3.3 | 4.4 | 0.18 | 416.4 |
| Glycol (TEG-EH) | | | | | |
| Isoheptyl Acetate | 15.75 | 3.76 | 4.43 | 0.2 | 181.9 |
| Decyl Acetate | 16.06 | 3.08 | 4.04 | 0.21 | 230.7 |
| 3-Heptyl Acetate | 15.85 | 3.34 | 4.58 | 0.22 | 182.6 |
| Sec-Heptyl Acetate | 15.98 | 3.34 | 4.84 | 0.27 | 181.4 |
| Isononyl Acetate | 15.82 | 3 | 3.82 | 0.28 | 214.7 |
| Isononyl Acetate | 15.82 | 3 | 3.82 | 0.28 | 214.7 |
| Dipropylene Glycol Dimethyl | 15.75 | 4.92 | 4.68 | 0.48 | 180.4 |
| Ether | | | | | |
| n-Heptyl Acetate | 15.8 | 2.9 | 5.5 | 0.55 | 182.7 |
| Dioctyl Decanedioate | 16.1 | 2.3 | 3 | 0.6 | 469.6 |
| Diisobutyl Carbinyl Acetate | 15.5 | 2.4 | 3.2 | 0.62 | 218.6 |
| Hexyl Acetate | 15.8 | 2.9 | 5.9 | 0.67 | 166.1 |
| Amyl Acetate | 15.8 | 3.3 | 6.1 | 0.69 | 148 |
| 2,2,4-Trimethyl-1,3-Pentanediol | 15.5 | 2.3 | 2.8 | 0.72 | 310.3 |
| Diisobutyrate (TXIB) | | | | | |
| n-Pentyl Propionate | 15.8 | 5.2 | 5.7 | 0.74 | 165.3 |
| n-Butyl Propionate | 15.7 | 5.5 | 5.9 | 0.87 | 149.3 |
| Isotridecanol | 15.92 | 3.07 | 6.64 | 0.87 | 241.4 |
| Isobutyl Isobutyrate (IBIB) | 15.1 | 2.8 | 5.8 | 0.88 | 169.8 |
| Diisobutyl Adipate | 16.7 | 2.5 | 6.2 | 0.93 | 269.6 |
| p-Chlorobenzotrifluoride | 17.3 | 3.88 | 2.88 | 0.96 | 135.2 |
| 1-Ethoxyethyl Acetate | 15.9 | 5.6 | 6.3 | 0.97 | 138.7 |
| Dipentene (Dl-Limonene) | 17.2 | 1.8 | 4.3 | 1.02 | 162.9 |
| Diethylene Glycol Butyl Ether | 16 | 4.1 | 8.2 | 1.37 | 208.2 |
| Acetate | | | | | |
| Dipropylene Glycol Monomethyl | 16.3 | 4.9 | 8 | 1.37 | 194.9 |
| Ether Acetate (DPM Acetate) | | | | | |
| Propylene Glycol Diacetate | 16.57 | 5.56 | 7.82 | 1.44 | 151.5 |
| Dimethyl Glutarate | 16.6 | 6.2 | 7.9 | 1.57 | 151.3 |
| Tripropylene Glycol Monomethyl | 16.22 | 5.93 | 8.27 | 1.58 | 212.2 |
| Ether (TPM) | | | | | |
| Isophorone (ISO) | 17 | 8 | 5 | 1.61 | 150.3 |
| Ethylene Glycol Butyl Ether | 15.3 | 7.5 | 6.8 | 1.62 | 171.2 |
| Acetate (EB Acetate, EB Ac) | | | | | |
| Glycerol Triacetate | 16.5 | 4.5 | 9.1 | 1.72 | 189 |
| Propylene Glycol Monobutyl Ether | 15.3 | 4.5 | 9.2 | 1.78 | 132 |
| (PNB) | | | | | |
| Dimethyl Adipate | 16.3 | 6.8 | 8.5 | 1.81 | 168.5 |
| Ethyl Acetoacetate (EA Ac) | 16.5 | 7.3 | 8.3 | 1.87 | 127.3 |
| Trimethylbenzene (TMB) | 18 | 1 | 1 | 1.91 | 137.3 |
| Aromatic 150 Hd (Aro 150) | 18.3 | 1.4 | 1.5 | 1.92 | 100 |
| Cyclohexanone | 17.8 | 8.4 | 5.1 | 2 | 104.2 |
| Propylene Glycol Monomethyl | 15.6 | 5.6 | 9.8 | 2.02 | 137.1 |
| Ether Acetate (PM Acetate, | | | | | |
| PM Ac) | | | | | |
| Propylene Glycol Monopropyl | 15.8 | 7 | 9.2 | 2.03 | 130.3 |
| Ether (PMP) | | | | | |
| Dimethyl Succinate | 16.1 | 7.7 | 8.8 | 2.06 | 135.1 |
| Dipropylene Glycol | 16.23 | 6.44 | 9.86 | 2.13 | 155.2 |
| Monomethyl Ether (DPM) | | | | | |
| Ethylene Glycol Mono 2-Ethyl | 16 | 4.1 | 10.5 | 2.14 | 194.7 |
| Hexyl Ether (EEH) | | | | | |
| 2,2,4-Trimethyl-1,3-Pentanediol | 15.1 | 6.1 | 9.8 | 2.15 | 227.4 |
| Monoisobutyrate (Texanol) | | | | | |
| Dipropylene Glycol Mono N-Butyl | 15.7 | 6.5 | 10 | 2.19 | 211.2 |
| Ether (DPNB) | | | | | |
| Propylene Glycol Monoethyl Ether | 15.7 | 6.5 | 10.5 | 2.34 | 115.6 |
| Diethylene Glycol Monobutyl | 16 | 7 | 10.6 | 2.43 | 170.4 |
| Ether (DB) | | | | | |
| Dipropylene Glycol Mono | 15.6 | 6.1 | 11 | 2.45 | 185.6 |
| N-Propyl Ether (DPNP) | | | | | |
| 2-Ethyl-Hexanol | 15.9 | 3.3 | 11.8 | 2.57 | 156.9 |
| Propylene Glycol Monomethyl | 15.6 | 6.3 | 11.6 | 2.66 | 98.2 |
| Ether (PM) | | | | | |
| Diacetone Alcohol (DAA) | 15.8 | 8.2 | 10.8 | 2.69 | 124.3 |
| Methyl Isobutyl Carbinol | 15.4 | 3.3 | 12.3 | 2.77 | 127.2 |
| Ethylene Glycol Monobutyl Ether | 16 | 5.1 | 12.3 | 2.77 | 131.8 |
| (EB, BC) | | | | | |
| 1-Nitropropane | 16.6 | 12.3 | 5.5 | 2.93 | 89.5 |
| Dimethyl Phthalate (DMP) | 18.6 | 10.8 | 4.9 | 2.95 | 163.4 |
| Ethyl Lactate | 16 | 7.6 | 12.5 | 3.09 | 115 |
| N,N-Dimethyl Acetamide | 16.8 | 11.5 | 9.4 | 3.19 | 93 |
| Cyclohexanol | 17.4 | 4.1 | 13.5 | 3.27 | 105.7 |
| n-Methyl-2-Pyrrolidone (NMP) | 18 | 12.3 | 7.2 | 3.33 | 96.6 |
| 1-Pentanol | 15.9 | 5.9 | 13.9 | 3.35 | 108.6 |
| Dipropylene Glycol (DPG) | 16.69 | 8.15 | 15.48 | 4.1 | 134.9 |
| Dimethyl Formamide (DMF) | 17.4 | 13.7 | 11.3 | 4.21 | 77.4 |
| γ-Butyrolactone (GBL) | 18 | 16.6 | 7.4 | 4.63 | 76.5 |
| Dimethyl Sulfoxide (DMSO) | 18.4 | 16.4 | 10.2 | 4.96 | 71.3 |
| Propylene Carbonate | 20 | 18 | 4.1 | 5.46 | 85.2 |
| Propylene Glycol (PG) | 16.8 | 10.4 | 21.3 | 6.18 | 73.7 |

High solids coating compositions of type disclosed herein, which include at least about 70 wt. % and, preferably, at least about 85 wt. % (on total resin basis) of a vinylidene difluoride-based polymer such as PVDF, may be used to form coil coatings having a substantially higher thickness than achievable with conventional PVDF coatings without the formation of blisters. For example, pigmented embodiments of the present composition including a substantial fraction (on total solvent basis) of solvent having a boiling point between about 180° C. to about 300° C. allow the formation of coil coatings with a dry film thickness (“DFT”) of more than two times the DFT achievable using conventional 70% PVDF coating compositions.

In some instances, it may be preferable include an amount of a solvent in addition to the DIBK, for example, that will not be totally volatilized under the baking conditions, such as isophorone, which can be used to form a dry film on a substrate. In such instances, the residual solvent remaining in the dry fluoropolymer-based film can act as a plasticizer. For other applications, it may be preferable to choose a solvent that will be essentially completely volatilized under the baking conditions employed. Preferably the solvent has a boiling point of about 170° C. to about 400° C. and more preferably about 200° C. to about 350° C. Preferably, such compositions include about 60-80 wt. % total solids and about 35 to about 50 wt. % of the PVDF polymer.

Other examples of suitable solvents which may be present, to some extent, as part of the solvent portion of the present compositions include phthalates such as butyl benzyl phthalate, TXIB (Trimethyl Pentanyl Diisobutyrate), and dialkyl phthalates (e.g., di(2-ethylhexyl) phthalate, dimethyl phthalate and dioctyl phthalate); aromatics such as toluene and xylenes; ketones such as isophorone; aliphatic dibasic acid esters such as dioctyl azelate, diisodecyl adipate and di(2-ethylhexyl) sebacate; phosphates such as trioctyl phosphate and 2-ethylhexyl diphenyl phosphate; epoxy plasticizers such as epoxidized soybean oil, epoxidized tall oil fatty acid 2-ethylhexyl esters, and other conventional polyester solvents commonly employed as plasticizers. Embodiments of the present invention intended for use as clear coatings typically include an alkyl substituted benzene, a phthalate, a glycol monoether, a glycol ester, and/or a monoester of an alkyleneoxy ether. Examples of suitable organic solvents which may be used to formulate clear versions of the present compositions include toluene, xylenes, dimethyl phthalate, propylene glycol methyl ether acetate, dipropylene glycol methyl ester acetate, butyl cellosolve, n-butanol, and mixtures thereof.

In order to improve the hardness and adhesion of the resulting cured film, the present compositions may include a hydroxy functional polymer, e.g., a hydroxy acrylic polymer. Those coating compositions which contain the hydroxy functional polymer typically include a curing agent, such as an aminoplast resin, as well.

The hydroxy functional polymer is subject to wide variation and is typically a solvent-soluble copolymer of monoethylenic monomers containing from about 1 wt. % to about 25 wt. % of a hydroxy functional monomer. The hydroxy functionality is generally the only reactive group in the copolymer, although a small amount of carboxylic acid functionality is permissible, though not essential. Preferably the hydroxy monomer content is from 2 to 10 wt. % of the monomer mixture.

Various hydroxy functional monomers can be used, but it is preferred to use an hydroxyalkyl ester of a monocarboxylic acid, such as acrylic acid or methacrylic acid. The alkyl groups contemplated are primarily those containing from 1-4 carbon atoms and illustrated by methyl ethyl, propyl or butyl, however esters of alcohols having up to 12 carbons may be also used. Preferred hydroxy functional monomers include 2-hydroxyethyl acrylate or 2-hydroxyethyl methacrylate. Hydroxy alkyl ethers, such as the hydroxyethyl ether of alkyl alcohol, are also useful.

The hydroxy functional copolymer may be produced by free-radical polymerization of a mixture of monoethylenically unsaturated monomers including the required proportion of a hydroxyalkyl acrylateor methacrylate; or hydroxyethyl acrylate or methacrylate. The other monomers are preferably acrylic and methacrylic esters of alcohols containing from 1 to 6 carbon atoms and preferably 1 or 2 carbon atoms. Most preferably, the non-hydroxylic monomers include at least about 50% methyl methacrylate, n-butyl methacrylate and/or ethyl acrylate. Small amounts, e.g., about 1-2 wt. %, of a carboxylic acid, like acrylic acid or methacrylic acid, may also be included in the monomer mixture. The hydroxy copolymer is preferably used in an amount of from about 1 to about 15 wt. % and more preferably from about 2 to about 10 wt. % of the composition. In some examples, other suitable unsaturated monomers may be included.

In some examples, a thermoplastic resin may be included in the composition (for example, a thermoplastic with a relatively low molecular weight) Such thermoplastic resin may make up about 0 wt. % to 50 wt. % and preferably 0 wt. % to 10 wt. % of the total resin solids present in the composition. When these acrylic resins are synthesized using DIBK as the solvent, the DIBK content is increased in the coating formulation prepared therefrom, providing access to high solids PVDF coating formulations with the aforementioned desired properties.

An aminoplast resin is typically added to the composition in a sufficient amount to cure the hydroxy functional polymer. The weight ratio of the hydroxy functional polymer to the aminoplast resin is typically about 2:1 to about 10:1 and preferably, about 3:1 to about 6:1. Aminoplast resins are based on the addition products of an aldehyde (preferably formaldehyde), with an amino- or amido-group carrying substance. Examples of suitable aminoplast resins include condensation products obtained from the reaction of alcohols and formaldehyde with melamine, urea or benzoguanamine. These condensation products can be monomeric or polymeric. Condensation products of other amines and amides can also be employed, for example, aldehyde condensates of triazines, diazines, triazoles, guanadines, guanamines and alkyl- and aryl-substituted melamines. Some examples of such compounds are N,N′-dimethyl urea, benzourea, dicyandimide, formaguanamine, acetoguanamine, glycoluril, ammelin 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. While the aldehyde employed is most often formaldehyde, other similar condensation products can be made from other aldehydes, such as acetaldehyde, crotonaldehyde, acrolein, benzaldehyde, furfural, glyoxal and the like.

A preferred aminoplast curing agent is simply a formaldehyde condensate with an amine, preferably melamine, to provide a heat-hardening methylol-functional resin. While many aminoplast resins are broadly useful, such as urea formaldehyde condensates and benzoguanamine formaldehyde condensates, it is preferred that the aminoplast resin be a polyalkoxymethyl melamine resin in which the alkoxy group contains from 1-4 carbon atoms. Appropriate melamine-formaldehyde condensates are readily available in commerce and are usually etherified with lower alcohols for use in organic solvent solution, as is well known. Examples of suitable aminoplast curing agents include an etherified melamine-formaldehyde condensate as solutions in organic solvent (e.g., a polymethoxymethyl melamine such as Cymel 303, available from Cytec). The aminoplast resin is typically present as from 0.1 to 10 wt. % of total resin solids, and, preferably, in an amount of from 0.2 to 3.0 wt. % of total resin solids.

While aminoplast resins are preferred for curing the hydroxy functional copolymer, it is also possible to use any curing agent reactive with hydroxy functionality, such as phenoplast resins or blocked polyisocyanates. Suitable blocked isocyanate curing agents include isophorone diisocyanate blocked with methyl ethyl ketoxime or octyl alcohol-blocked 2,4-toluene diisocyanate. The class of blocked isocyanate curing agents is well known, and these agents are well known to effect cure by forming urethane groups with the hydroxy functionality on the coating composition when baking causes the blocked isocyanate groups to dissociate and become active.

When the present compositions are to be used to form a clear coating, the formulation typically includes a thermoplastic resin, such as a thermoplastic acrylic polymer. The thermoplastic acrylic resins typically are the polymerized ester derivatives of acrylic acid and methacrylic acid. The esters are formed by the reaction of the acrylic of methacrylic acid with suitable alcohols, for example, methyl alcohol, ethyl alcohol, propyl alcohol, butyl alcohol and 2-ethylhexyl alcohol. Generally speaking the larger the alcohol portion of the ester, the softer and more flexible the resultant resin. Methacrylic esters tend to form harder films than the corresponding acrylic ester. Monomers, such as styrene, vinyl toluene, vinyl chloride, and vinylidene chloride can also be reacted with the acrylic and methacrylic esters so as to produce thermoplastic resins with excellent properties. An especially suitable resin is a copolymer of methyl methacrylate and ethyl acrylate, having a Mw of between about 50,000 and about 150,000.

The present compositions may be clear (substantially lacking in color) where they are designed to be applied as a protective top coat. More commonly however, the coating compositions include a pigment. The pigment loading will depend on a number of factors including the desired opacity, color and chemical resistance. Typical, pigmented versions of the present composition include about 5 to about 25 and preferably about 10 to about 20 wt. % of one or more pigments.

Conventional additives including surfactants, antioxidants, ultraviolet light absorbers and stabilizers, rheology control agents, coalescing agents and the like may also be added to the present coating composition. For example, in order to prevent yellowing and/or deterioration during baking, the present coating compositions may include an antioxidant, such as Irgonox 1010 (available from Ciba-Geigy). A flatting agent, such as DeGussa product OK-412 or a silica (e.g., Syloid 7000 available from W. R. Grace) may be added to reduce the 60° gloss reading into the desired range. An additive such as a wax (e.g., Polymekon wax or Paxwax) or micronized PTFE may be added to improve surface lubricity and thus improve mar resistance.

The coating composition of the present disclosure may be prepared by conventional methods. For example, the coating composition may be prepared by blending the various components using a high-speed disperser and milling equipment, such as a small media mill.

Any of a variety of standard application methods may be used to apply the coating composition, e.g., brush, bar, slot, roll coating or spraying. The desired viscosity will vary depending upon the particular end use, desired dry film thickness and method of application of the coating. For example, where the coating composition is to be applied through a coil coating process (e.g., by reverse roll coating), the composition preferably includes at least about 40 wt. % and, more preferably, about 55 to about 80 wt. % total solids and typically has a viscosity of about 40 to about 120 seconds and preferably about 60 to about 120 seconds (#2 Zahn.). In some examples, the composition includes about 40 to about 45 wt % total solids and has a viscosity of about 20 to about 40 seconds (#4 Zahn) and about 500 to about 1500 seconds 10 rpm, Brookfield #4 spindle). In some examples, the composition includes about 45 to about 55 wt % total solids and has a viscosity of about 20 to about 40 seconds (#4 Zahn) and about 700 to about 1300 seconds (10 rpm, Brookfield #4 spindle). In some examples, the composition includes about 40 to about 55 wt % total solids and has a viscosity of about 20 to about 40 seconds (#4 Zahn) and about 500 to about 1500 seconds 10 rpm, Brookfield #4 spindle). Coating compositions to be applied via a coil coating process more preferably have a viscosity of about 80 to about 105 seconds (#2 Zahn.) and include about 35 wt. % to about 50 wt. % of the PVDF polymer (based on total composition weight).

Roll coating of a composition of this type allows the formation of films having a wet film thickness of 0.5 to 5 mils, or in some examples, of 0.5 to 10 mils. Roll coating, including but not limited to, coil coating of a composition of this type, allows the formation of films having a wet film thickness of 0.2 to 2 mil or, in some examples, of 0.2 to 6 mils or 0.7 to 6 mils. In other embodiments compositions preferably include at least about 50 wt. % and, more preferably, about 55 to about 80 wt. % total solids and typically has a viscosity of 900-5000 Pa·s (10 rpm, Brookfield #4 spindle), preferrable less than 4000 Pa·s (10 rpm, Brookfield #4 spindle), more preferably less than 2000 Pa·s (10 rpm, Brookfield #4 spindle) and more preferably less than 1000 Pa·s (10 rpm, Brookfield #4 spindle). In still yet other embodiments compositions preferably include at least about 50 wt. % and, more preferably, about 55 to about 80 wt. % total solids and typically has a viscosity of 400-1500 Pa·s (100 rpm, Brookfield #4 spindle), preferrable less than 1500 Pa·s (100 rpm, Brookfield #4 spindle), more preferably less than 1000 Pa·s (100 rpm, Brookfield #4 spindle) and more preferably less than 500 Pa·s (100 rpm, Brookfield #4 spindle). Where the present composition is employed as a topcoat (for example, a coat over a primer), the composition is typically applied at a wet film thickness of 1 to 3 mils and produces a cured dry film thickness of about 0.2 to 1.0 mils, and the dry film total thickness for the multi-coat system is about 0.9 to 2.3 mils.

Where a spray application is to be utilized, pigmented versions of the present composition preferably include at least about 50 wt. % total solids and typically have a viscosity of about 25 to about 60 seconds (#2 Zahn). Where the present composition is to be used to form a clear coating, total solids contents of 35 to 45 wt. % and PVDF contents of at least about 30 wt. % are common. Such composition coatings can be used to prepare spray coatings (e.g., via electrostatic spray) having a wet film thickness of about 2 to about 4 mils and a dry film thickness of about 1.0 to about 2.0 mils. Where the composition is used to form a clear top coat, spray applications to produce coatings having a wet film thickness of about 1 to 2 mils and a dry film thickness of about 0.3 to 0.7 mils are common. In some instances, the present composition may be thinned prior to spray application with a suitable reducing solvent, e.g., xylene, butyl carbitol or a combination thereof. The particular reducing solvent employed depends upon a number of factors including line conditions and the DFT desired or specified.

The dispersion coatings of the present disclosure may be applied to a substrate by means known in the art, including but not limited to brushing, bar coating, roll coating, inkjet application and spraying. The coating may be applied to one, or more sides of the substrate. The substrate is generally metallic, including but not limited to aluminum, hot dipped galvanized steel, and zinc-aluminum alloys on steel. Two or more coats of the dispersion coating may be added, and the metal may be physically or chemically primed prior to coating. In a preferred aspect, the coating compositions described herein are applied using a coil coating as known in the art, including for example by a reverse roll coating process. Following application of the fluoropolymer dispersion coating the substrate is heated to cure the coating and form a tough film.

The metal surface to be coated with a fluoropolymer- or acrylic-based primer coating, can coated with a primer containing PVDF (such as a primer based on a blend of PVDF and a hydroxy functional acrylic copolymer) prior to the application of the present coating composition. A number of conventional flouropolymer- and acrylic-based primers are known to those skilled in the art. Examples of suitable primers which may be applied to a metal surface prior to the present compositions are disclosed in U.S. Pat. No. 4,684,677, the disclosure of which is herein incorporated by reference. Other suitable primers include those based on commercially available acrylic emulsions, such as AC-1822 (available from Rohm & Hass), UCAR® 452 and UCAR® 455 (available from Union Carbide Corp.), Joncryl® 537 (available from S. C. Johnson) and Sequabond® TR7830 (available from Sequa Chemicals, Chester, S.C.).

Where large rolls of thin gauge metal are to be coated, it is advantageous to apply the coating composition via a coil coating process, such as reverse roll coating. When the coating is carried out using such a process, the coated metal substrate is typically cured by heating for about 10 to about 50 seconds at a temperature of about 200° C. to 300° C. If a spray coating process is used the resulting film is usually cured by heating for about 10 to about 15 minutes at a temperature of about 210° C. to about 270° C. The baking temperatures are not critical, but must be high enough to cause the fluoropolymer particles in the dispersion to coalesce with acrylic resin into a continuous film.

In certain aspects, present composition is generally suitable for use in coil coating and spray applications (e.g., at a total solids content of about 30 to about 70 wt. %). If desired, however, the composition may be thinned prior to being applied by the addition of a solvent. For spray applications additional solvent, such as xylene, toluene, methyl ethyl ketone or 2-butoxy ethanol, or the like, may be added to reduce the resin solids content of the composition. The viscosity desired will vary depending upon the spray equipment and atmospheric conditions. When applied via spray methods, pigmented versions of the present composition typically have a viscosity of 20-60 (#2 Zahn) and a total solids content of about 50 to about 70 wt. % (total resin solids of about 35 to about 50 wt. %). Clear versions of the present coating composition generally have a similar viscosity and contain a total resin solids content of about 30 to about 45 wt. %. Very often, the clear versions are thinned to some degree with an organic solvent prior to spray application (e.g., by the addition of 1 to 2 parts butyl carbitol per 10 parts of the clear coating composition).

The baking temperatures are not critical but must be high enough to cause the fluoropolymer particles, e.g., PVDF particles, present in the dispersion to coalesce into a continuous film. A temperature of at least about 210° C. for about 10 minutes is generally adequate for this purpose. This temperature is more than sufficient to cure any hydroxy functional polymer present thereby providing enhanced solvent resistance and improved hardness. In coil coating processes, the oven dwell temperature is often no more than about 30 seconds and oven temperatures as high as 300° C. to 400° C. may be used. PVDF based films are preferably cured by baking for a dwell time of about 0.25 to 1.0 minutes such that the metal substrate reaches a peak metal temperature of 225° C. to 260° C.

### EXAMPLES

### Example 1

Compositions of fluorosurfactant-free PVDF coatings were prepared according to the following formulations wherein the solvent X is a solvent:

TABLE 2
Compositions of Fluorosurfactant-free PVDF Coatings

| NVM | VOC | Isophorone | Solvent X |
|---|---|---|---|
| 58.53% | 41.47% | 21.47% | 0-20% |

FIG. 1 depicts rheology profiles (shear increase) of example compositions, where different solvents were utilized.

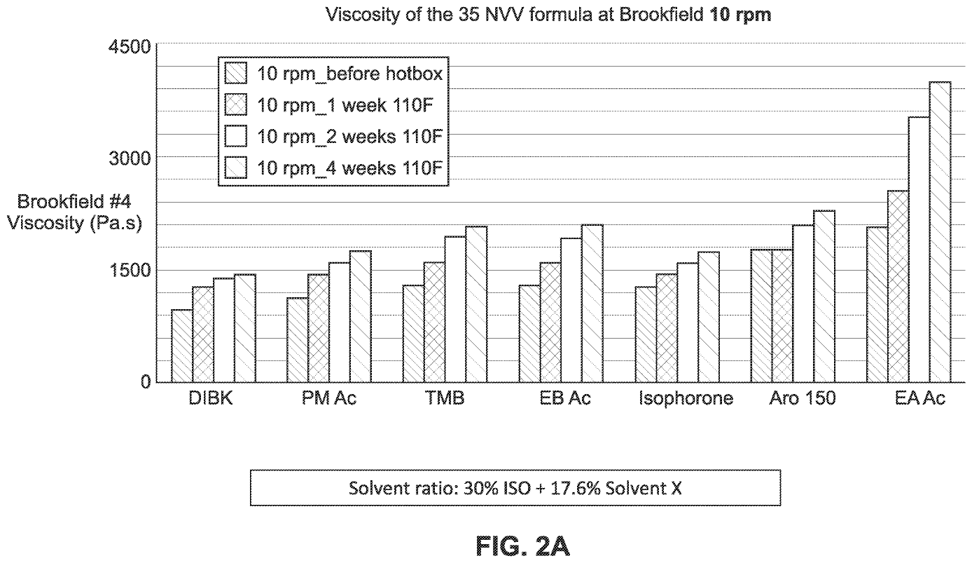

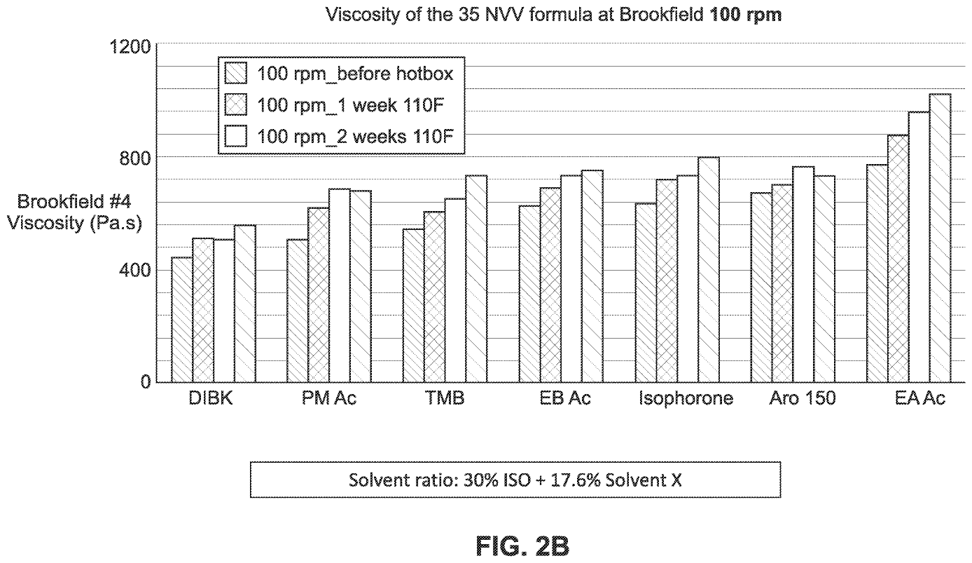

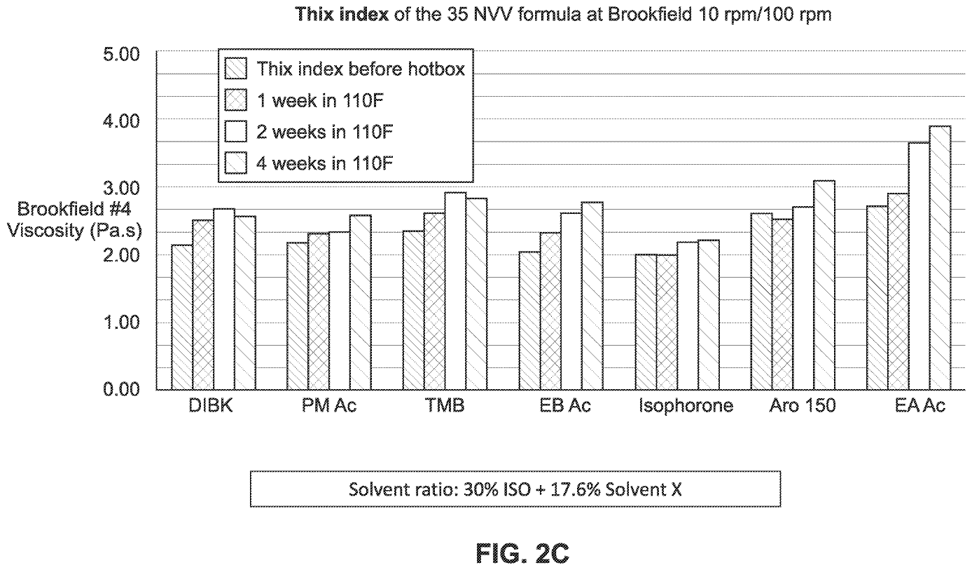

The viscosity of the various formulations were recorded in Table 3 below as well as in FIGS. 2A-2C. FIG. 2A depicts the viscosity of the example composition, utilizing a Brookfield viscometer at 10 rpm. Data included in FIG. 2A includes the viscosities measured prior to placing in a hotbox, after one week in the hotbox at 110° F., after two weeks in the hotbox at 110° F., and after four weeks in the hotbox after 110° F. FIG. 2B depicts the viscosity of the example composition, utilizing a Brookfield viscometer at 100 rpm. Data included in FIG. 2B includes the viscosities measured prior to placing in a hotbox, after one week in the hotbox at 110° F., and after two weeks in the hotbox at 110° F. FIG. 2C depicts the thixotropic index (also referred to as a thix index) of the example composition of the present disclosure, where the thix index indicates a ratio of the viscosities measured at 10 rpm over the viscosities measured at 100 rpm. Data included in FIG. 2C includes the viscosities measured prior to placing in a hotbox, after one week in the hotbox at 110° F., after two weeks in the hotbox at 110° F., and after four weeks in the hotbox after 110° F.

Tests were conducted at around one week at room temperature after initial formulation.

TABLE 3
Viscosity of Test Formulations

| | | Brookfield #4 | | |
|---|---|---|---|---|
| Coil PVDF formula | | Viscosity | | |
| Major solvent | | 10 | 100 | Thix |
| (30%) | Solvent X | rpm | rpm | Index |
| Isophorone | Di-Isobutyl Ketone (DIBK) | 960 | 448 | 2.1 |
| | Propylene Glycol Monomethyl | 1120 | 512 | 2.2 |
| | Ether Acetate (PM Acetate, PM | | | |
| | AC) | | | |
| | Trimethylbenzene (TMB) | 1280 | 544 | 2.4 |
| | Ethylene Glycol Butyl Ether | 1280 | 624 | 2.1 |
| | Acetate (EB Acetate, EB Ac) | | | |
| | Isophorone | 1280 | 640 | 2.0 |
| | Aromatic 150 Hd (Aro 150) | 1760 | 672 | 2.6 |
| | Ethyl Acetoacetate (EA Ac) | 2080 | 768 | 2.7 |
| | Dipropylene Glycol | 3200 | 1040 | 3.1 |
| | Monomethyl Ether (DPM) | | | |
| | Diethylene Glycol Monobutyl | 4480 | 1328 | 3.4 |
| | Ether (DB) | | | |
| | Diacetone alcohol | 4960 | 1216 | 4.1 |

The condition for testing included: utilization of a Brookfield #4 Spindle; agitation 5 minutes before doing the testing; and testing at room temperature.

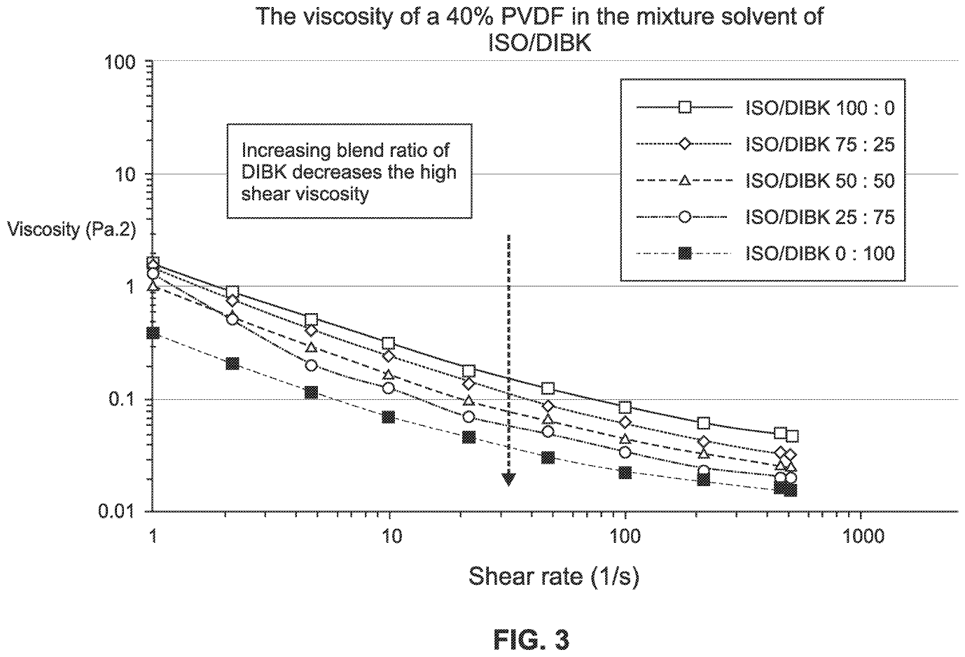

As can be seen viscosity of the formulations containing a mixture of isophorone with either DIBK, PM Ac, TMB, and EB Ac where improved over formulations containing isophorone alone. As shown in FIG. 3 the increasing the amount of DIBK in the formulation decreases the high shear viscosity. In formulations containing 40 wt % PVDF in isophorone. In addition, the combination of BYK-2117 and DIBK allowed for high-TiO2 formulas.

### Example 2

Compositions of four coatings were prepared according to the following formulations of Table 4. Compositions 1 and 2 included PVDF in PM Acetate (as a solvent) as the resin component, and Isophorone, etc. as the solvent component. Composition 1 included only Solsperse 20k as a dispersant. Composition 2 included Solsperse 20k and Tetronic® 150R1 (herein “T150R1” or “T150”) as dispersants.

Compositions 3 and 4 included PVDF in DIBK (as a solvent) as the resin component, and the solvents used were isophorone-free (DIBK solvent). Composition 3 included a 2 to 1 ratio by weight of Solsperse 20k to Solsperse 75K as dispersants. Composition 4 included a 2 to 1 ratio by weight of Solsperse 20k to Solsperse 75K, as well as T150 as dispersants.

The PVDF included in these four compositions for the Example 2 was 20C7001 Arkema PVDF. 20C7001 Arkema is a PFOA-free PVDF material from Arkema with LOT number 21C7001.

Viscosity tests were conducted at around one week at room temperature after initial formulation. The testing conditions for the tests utilizing the Brookfield #4 Spindle included: Agitation for five (5) minutes prior to testing and testing performed at room temperature. The testing conditions for the tests utilizing the Zahn #4 cup included: Agitation for five (5) minutes prior to testing and testing performed at room temperature

Compositions 3 and 4 are both fluorosurfactant and PFOA-free and contain acrylic resin synthesized in DIBK.

TABLE 4
Compositions of PVDF Coatings

| | | | | | | | Brookfield | | |
|---|---|---|---|---|---|---|---|---|---|
| | | | | | | | #4 | | |
| Composition | | | | | | | 10 | 100 | Zahn |
| No. | | Resin | Solvent | Dispersants | NVM/% | NVV/% | rpm | rpm | #4 |
| 1 | PVDF | Acrylic | Isophorone, | 20k only | 56.32 | 44.08 | 640 | 496 | |
| | Intermediate | resin | PM | | | | | | |
| | sample | and | Acetate | | | | | | |
| 2 | White | PVDF | etc. | 20k + T150 | 58.5 | 42.44 | 1440 | 848 | 31 s |
| | letdown | | | | | | | | |
| | sample | | | | | | | | |
| 3 | 9344- | Acrylic | Isophorone- | 20k/75k | 64.15 | 51.38 | 1120 | 832 | |
| | 3-PVDF | resin | free; | 2:1 | | | | | |
| | Intermediate | and | DIBK, | | | | | | |
| 4 | 9344- | PVDF | etc. | 20k/75k | 64.42 | 48.43 | 800 | 512 | 29 s |
| | 3-White | | | 2:1 + T150 | | | | | |
| | letdown | | | | | | | | |

As compared to Compositions 1 and 2, the higher-solids compositions (Compositions 3 and 4) exhibited higher NVV (non-volatile volume) (and NVM) values (for example, as demonstrated above in Table 4, Composition 4 was able to achieve 48.43% NVV as compared to the 42.44% NVV of Composition 2).

Composition 3 and 4 including DIBK in the solvent also demonstrated lower viscosities as compared to Compositions 1 and 2, respectively (as demonstrated above in Table 4).

Although only exemplary embodiments of the present disclosure have been described in detail above, those skilled in the art will readily appreciate that many modifications are possible without materially departing from the novel teachings and advantages of this disclosure. Accordingly, all such modifications are intended to be included within the scope of this disclosure as defined in the following claims.

While particular uses of the technology have been illustrated and discussed above, the disclosed technology can be used with a variety of environments in accordance with many examples of the technology. The above discussion is not meant to suggest that the disclosed technology is only suitable for implementation within the environments shown and described above.

Where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or operations are disclosed only as illustrative aspects. The scope of the technology is defined by the following claims and any equivalents therein. Examples of the disclosure may be described according to the following aspects.

Aspect 1. A coating composition having a dispersed fluoropolymer resin, said composition comprising: i) at least about 30 wt. % of PVDF polymer based on resin solids basis; ii) at least one organic solvent including a non-aromatic ester, a non-aromatic ketone or a mixture thereof.

Aspect 2. The coating composition of aspect 1 comprising at least about 85 wt. % PVDF on a resin solids basis.

Aspect 3. The coating composition of aspects 1-2 wherein the at least one organic solvent is di-isobutyl ketone (DIBK).

Aspect 4. The coating composition of aspects 1-3 wherein the organic solvent includes between 1 wt. % and 60 wt. % of the non-aromatic ester or non-aromatic ketone.

Aspect 5. The coating composition of aspects 1-3, wherein the organic solvent includes between 1 wt′% and 20 wt. % of a non-aromatic ester or non-aromatic ketone having a boiling point of less than 200° C.

Aspect 6. The coating composition of aspects 1-5 wherein the non-aromatic ester comprises an alkanediol diester having from 10 to 30 carbon atoms.

Aspect 7. The coating composition of aspects 1-5 wherein the non-aromatic ketone comprises an of a C6 to C12 branched or unbranched aliphatic ketone.

Aspect 8. The coating composition of aspect 7, wherein the non-aromatic ketone further includes isophorone, di-isobutyl ketone, and mixtures thereof.

Aspect 9. The coating composition of any of the preceding aspects, wherein the organic solvent further includes toluene, xylenes, or mixtures thereof.

Aspect 10. The coating composition of any of the preceding aspects, wherein the coating composition further comprises about 0.01 to about 3.0 wt. % of a hyperdispersant.

Aspect 11. The coating composition of aspect 10 wherein the hyperdispersant is selected from the group consisting of oxalkylated amino alcohol, polymeric oxyalkylated ethanediamine, or a mixture thereof.

Aspect 12. The coating composition of any of the preceding aspects, wherein the composition is substantially free from fluorosurfactants.

Aspect 13. The coating composition of any of the preceding aspects, wherein the composition comprises of (i) at least about 50 wt. % PVDF polymer based on the total amount of resin solids and (ii) at least about 30 wt. % of the organic solvent has a boiling point greater than 200° C.

Aspect 14. The coating composition of any of the preceding aspects further comprising inorganic pigment; wherein the coating composition has a #2 Zahn viscosity of about 25 to about 60 seconds.

Aspect 15. The coating composition of any of the preceding aspects wherein the PVDF-based polymer includes PVDF having an Mw of about 350,000 to about 450,000, a Mw/Mn ratio of about 3.5 to about 5.0, and a melting point of about 150-170° C.

Aspect 16. The coating composition of any of the preceding aspects, wherein the composition further comprises a hydroxy functional polymer and aminoplast resin.

Aspect 17. A composite material comprising a metal substrate having at least one surface which includes a PVDF based film formed by a process comprising: coating the at least one surface with the coating composition of any of the preceding aspects to form a coated metal substrate; and heating the coated metal substrate.

Aspect 18. A coating composition having a dispersed PVDF resin comprising: i) at least about 30 wt. % PVDF on a total resin solids basis; and ii) organic solvent which includes between 0 and 20 wt. % of an organic solvent with an HSP Polarity δP≤6 and hydrogen-bonding component, δH≤10, based on the weight of the total composition.

Aspect 19. The coating composition of aspect 18 comprising 30 wt. % of isophorone.

Aspect 20. The coating composition of aspects 18-19, comprising at least about 85 wt. % polyvinylidene difluoride on a resin solids basis.

Aspect 21. The coating composition of aspects 18-20, wherein the coating composition is substantially free from fluorosurfactants.

Aspect 22. The coating composition of aspects 18-21, wherein the coating composition further comprises an inorganic pigment;

Aspect 23. The coating composition of aspect 22 further comprising: iv) a hyperdispersant which includes oxyalkylated amino alcohol, polymeric oxyalkylated ethanediamine, or a mixture thereof; and v) about 5 to about 15 wt. % thermoplastic acrylic polymer on a resin solids basis.

Aspect 24. A coating composition comprising: i) at least about 50 wt. % PVDF on a resin solid basis; ii) a first organic solvent selected from the group consisting of: DIBK (diisobutyl ketone), DAA (diacetone alcohol), DB (diethylene glycol butyl ether), DPM (dipropylene glycol methyl ether), Aro 150 (Aromatic 150), EA Ac (Ethyl Acetoacetate), TMB (trimethylbenzene), EB Ac (ethylene glycol butyl ether acetate), PM Ac (propylene glycol methyl ether acetate), and mixtures there of; and iii) a second organic solvent which includes isophorone, xylenes, toluene, or a mixture thereof.

Aspect 25. The coating composition of aspect 24, wherein the coating composition further comprises a polymeric dispersant that is free from fluorosurfactants.

Aspect 26. The coating composition of any one of the preceding aspects wherein the composition comprises at least about 50 wt. % total solids.

1. A coating composition having a dispersed fluoropolymer resin, said composition comprising:
i) at least about 30 wt. % of PVDF polymer based on resin solids basis;
ii) at least one organic solvent including a non-aromatic ester, a non-aromatic ketone or a mixture thereof.

2. The coating composition of claim 1 comprising at least about 85 wt. % PVDF on a resin solids basis.

3. The coating composition of claim 1 wherein the at least one organic solvent is di-isobutyl ketone (DIBK).

4. The coating composition of claim 1 claims 1-3 wherein the organic solvent includes between 1 wt. % and 60 wt. % of the non-aromatic ester or non-aromatic ketone.

5. The coating composition of claim 1, wherein the organic solvent includes between 1 wt′% and 20 wt. % of a non-aromatic ester or non-aromatic ketone having a boiling point of less than 200° C.

6. The coating composition of claim 1 wherein the non-aromatic ester comprises an alkanediol diester having from 10 to 30 carbon atoms.

7. The coating composition of claim 1 wherein the non-aromatic ketone comprises an of a C6 to C12 branched or unbranched aliphatic ketone.

8. (canceled)

9. The coating composition of claim 1, wherein the organic solvent further includes toluene, xylenes, or mixtures thereof.

10. The coating composition of claim 1, wherein the coating composition further comprises about 0.01 to about 3.0 wt. % of a hyperdispersant, wherein the hyperdispersant is selected from the group consisting of oxalkylated amino alcohol, polymeric oxyalkylated ethanediamine, or a mixture thereof.

11. (canceled)

12. The coating composition of claim 1, wherein the composition is substantially free from fluorosurfactants.

13. The coating composition of claim 1, wherein the composition comprises of (i) at least about 50 wt. % PVDF polymer based on the total amount of resin solids and (ii) at least about 30 wt. % of the organic solvent has a boiling point greater than 200° C.

14. (canceled)

15. The coating composition of claim 1 wherein the PVDF-based polymer includes PVDF having an Mw of about 350,000 to about 450,000, a Mw/Mn ratio of about 3.5 to about 5.0, and a melting point of about 150-170° C.

16. The coating composition of claim 1, wherein the composition further comprises a hydroxy functional polymer and aminoplast resin.

17. A composite material comprising a metal substrate having at least one surface which includes a PVDF based film formed by a process comprising:
coating the at least one surface with the coating composition of any of the preceding claims to form a coated metal substrate; and
heating the coated metal substrate.

18. A coating composition having a dispersed PVDF resin comprising:
i) at least about 30 wt. % PVDF on a total resin solids basis; and
ii) organic solvent which includes between 0 and 20 wt. % of an organic solvent with an HSP Polarity δP≤6 and hydrogen-bonding component, δH≤10, based on the weight of the total composition.

19. The coating composition of claim 18 comprising 30 wt. % of isophorone.

20. The coating composition of claim 18, comprising at least about 85 wt. % polyvinylidene difluoride on a resin solids basis.

21. The coating composition of claim 18, wherein the coating composition is substantially free from fluorosurfactants.

22. (canceled)

23. The coating composition of claim 18 further comprising:
iv) a hyperdispersant which includes oxyalkylated amino alcohol, polymeric oxyalkylated ethanediamine, or a mixture thereof;
v) about 5 to about 15 wt. % thermoplastic acrylic polymer on a resin solids basis; and
vi) an inorganic pigment.

24. A coating composition comprising:
i) at least about 50 wt. % PVDF on a resin solid basis;
ii) a first organic solvent selected from the group consisting of: DIBK (diisobutyl ketone), DAA (diacetone alcohol), DB (diethylene glycol butyl ether), DPM (dipropylene glycol methyl ether), Aro 150 (Aromatic 150), EA Ac (Ethyl Acetoacetate), TMB (trimethylbenzene), EB Ac (ethylene glycol butyl ether acetate), PM Ac (propylene glycol methyl ether acetate), and mixtures there of; and
iii) a second organic solvent which includes isophorone, xylenes, toluene, or a mixture thereof.

25. (canceled)

26. (canceled)
